(19) United States
(12) Patent Application Publication
(10) Pub. No.: US 2009/0147132 A1
(43) Pub. Date: Jun. 11, 2009

(54) IMAGE INTERPOLATION APPARATUS

(75) Inventors: Teruyuki Sato, Kawasaki (JP); Takashi Hamano, Kawasaki (JP); Ryuta Tanaka, Kawasaki (JP); Atsuko Tada, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/326,167

(22) Filed: Dec. 2, 2008

(30) Foreign Application Priority Data
Dec. 7, 2007 (JP) 2007-317531

(51) Int. Cl. H04N 7/01; G06K 9/32

(52) U.S. Cl. 348/451; 382/300; 348/E07.003

(57) ABSTRACT

A first feature value calculator calculates a feature value of an entire screen, and a second feature value calculator calculates a feature value of only an image area designated by designation data stored in a designation data storage. An interpolation determiner outputs a control signal indicative of interpolation-ON if the two feature values are matched or outputs a control signal indicative of interpolation-OFF if not. A center area interpolator uses a motion vector output from a motion estimator to generate an interpolated image within an image area. Side area interpolator performs process of interpolating a side area of the screen on interpolation-ON and stops the process of interpolating a side area of the screen on interpolation-OFF. Therefore, on interpolation-ON, an interpolated frame interpolating the entire screen is output. On interpolation-OFF, an interpolated frame interpolating only the designated image area is output.

### BACKGROUND OF THE INVENTION

1. Field of the Invention

The present invention relates to an image interpolation technology that generates a nonexistent video frame between two video frames by interpolation.

2. Description of the Related Art

A liquid crystal display (LCD) which is one of displays to be used in thin televisions employs “hold display” that keeps holding an image of a previous video frame until image data of a next video frame comes, unlike “impulse display” that flashes an image momently on a display device such as a Cathode Ray Tube (CRT) and a plasma display.

The hold display causes a phenomenon called “motion judder” on objects moving in the video due to a mismatch between motion interpolation resulted from the following of the eyeball and the hold display with no positional change. In addition, in one segment broadcasting which has started in recent years, unnatural motions may be prominent due to its lower frame rate, about 15 fps, than that of the current analog broadcasting.

In order to solve the problem, it is effective to generate a middle frame between video frames and show a video with a motion interpolation. FIG. 19 is a diagram illustrating a motion interpolation. A motion vector within a screen is obtained from a frame 11 at a time t-1 and a frame 13 at a time t. Then, a motion compensation after ½ unit time results an interpolated frame 12 at the middle time t-½. This may improve the video quality.

In broadcasting, a video to be interpolated does not always exist on the entire screen. For example, it corresponds to a case where non-picture areas (black bar area/wallpaper area) for adjusting picture size are provided, typically like letterbox bars and side panels. FIG. 20 is a diagram illustrating an entire screen area including black bars of typical side panels. Without proper control of the interpolation in the non-picture area, the borders of the black bars appear to tremble, which stands out as visual deterioration.

In a case where the frame interpolation process is performed at a position close to a display device, not only video signals but also other display data including, for example, data on a text area and a pictogram display area may be processed as an input video. In this case, only the picture part may be enlarged to display on the entire screen by a user operation, and the borders of the areas do not always continue through time though there is a certain rule of screen design.

Japanese Laid-open Patent Publication No. 6-276510 discusses a method, as a technology for controlling the motion estimation in a non-picture area, which limits the direction of search on the basis of the current coordinates data in order to prevent the motion estimation at a side area of the screen from referring to the area outside the screen.

FIG. 21 is a diagram illustrating an interpolation method discussed by Japanese Laid-open Patent Publication No. 6-276510. A motion estimator 21 recognizes a screen size on the basis of image area data 23 to obtain a motion vector thereof An interpolated image generator 22 generates an interpolated frame on the basis of the motion vector.

Japanese Laid-open Patent Publication No. 2005-287049 discusses a method, as a technology for generating an interpolation picture in a non-picture area, which inhibits generation of new image data when a reference image determined on the basis of a motion vector exists at an unacceptable image position.

FIG. 22 is a diagram illustrating a method for controlling ON/OFF of interpolation discussed in Japanese Laid-open Patent Publication No. 2005-287049. A motion estimator 31 estimates a motion vector and outputs it to a step over checker 33 and an interpolated image generator 32. The step over checker 33 determines borders of the picture area in accordance with image area data 34 and turns off the interpolation process performed by the interpolated image generator 32 when the reference image determined on the basis of the motion vector is at an unacceptable image position.

However, the aforesaid conventional image interpolation methods have problems as follows.

The interpolation method of Japanese Laid-open Patent Publication No. 6-276510 may not properly limit the direction of motion estimation unless the image area data that designates a screen size is given at an appropriate time. It neither discusses how the switching of screen sizes is detected.

The interpolation method of Japanese Laid-open Patent Publication No. 2005-287049 assumes that the borders of the picture area is known and does not change. Thus, the method may not handle borders of a picture area changing in time.

### SUMMARY

Accordingly, it is an object of the present invention to provide a stable video by preventing deterioration of quality due to improper interpolation in a case where the video to be applied with image interpolation contains a non-picture area.

According to an aspect of the present invention, provided is an image interpolation apparatus for generating an interpolated video frame on the basis of a preceding video frame and a following video frame. The image interpolation apparatus includes a designation data storage, a first calculator, a second calculator, a determiner, a frame generator, and a controller. The designation data storage stores area data designating an image area within a screen area. The first calculator calculates a first feature value for the screen area. The second calculator calculates a second feature value for the image area in accordance with the area data stored in the designation data storage. The determiner determines whether the first feature value matches the second feature value. The frame generator generates the interpolated video frame including interpolated data generated on the basis of frame data of the preceding video frame and frame data of the following video frame. The controller controls the frame generator to generate the interpolated video frame including interpolated data for the image area and non-interpolated data for an area other than the image area within the screen area when a determination result by the determiner indicates a mismatch. The non-interpolated data may be the frame data of the preceding video frame or the frame data of the following video frame.

The first feature value may preferably be a value of an average motion vector.

The frame generator may include a first generator for generating the interpolated data for the image area, and a second generator for generating interpolated data for the area other than the image area within the screen area. In such a configuration, the controller may control the second generator to perform generation of the interpolated data when the determination result by the determiner indicates a match, and stop generation of the interpolated data when the determination result by the determiner indicates a mismatch.

### BRIEF DESCRIPTION OF THE DRAWINGS

FIG. 1 is a diagram illustrating an exemplary configuration of an image interpolation apparatus according to an embodiment of the present invention;

FIG. 2 is a diagram illustrating an image area in a screen with side panels;

FIG. 3 is a diagram illustrating black bars in side panel areas;

FIG. 4 is a diagram illustrating an entire screen area including side panel areas;

FIG. 5 is a diagram illustrating side panel areas in a screen;

FIG. 6 is a diagram illustrating examples of searchable area and feature value calculation areas within a video frame;

FIG. 7 is a diagram illustrating an example of a method for calculating a feature value in a case of side panels;

FIG. 8 is a diagram illustrating an entire screen area including black bars of typical letterbox bars;

FIG. 9 is a diagram illustrating an image area in a screen with letterbox bars;

FIG. 10 is a diagram illustrating black bars in letterbox bar areas;

FIG. 11 is a diagram illustrating an entire screen area including letterbox bar areas;

FIG. 12 is a diagram illustrating letterbox bar areas in a screen;

FIG. 13 is a diagram illustrating an example of a method for calculating a feature value in a case of letterbox bars;

FIG. 14 is a diagram illustrating an exemplary configuration of a frame rate converter employing an image interpolation apparatus according to an embodiment of the present invention;

FIG. 15 is a diagram illustrating an exemplary configuration of a video player employing a frame rate converter;

FIG. 16 is a diagram illustrating an exemplary configuration of a video display apparatus employing a frame rate converter;

FIG. 17 is a diagram illustrating an exemplary configuration of an information processing apparatus;

FIG. 18 is a diagram illustrating a method for providing a program and data to an information processing apparatus;

FIG. 19 is a diagram illustrating a motion interpolation;

FIG. 20 is a diagram illustrating an entire screen area including black bars of typical side panels;

FIG. 21 is a diagram illustrating an interpolation method employing image area data;

FIG. 22 is a diagram illustrating a method for controlling ON/OFF of interpolation;

### DESCRIPTION OF THE PREFERRED EMBODIMENTS

With reference to the drawings, embodiments of the present invention will be discussed in detail below.

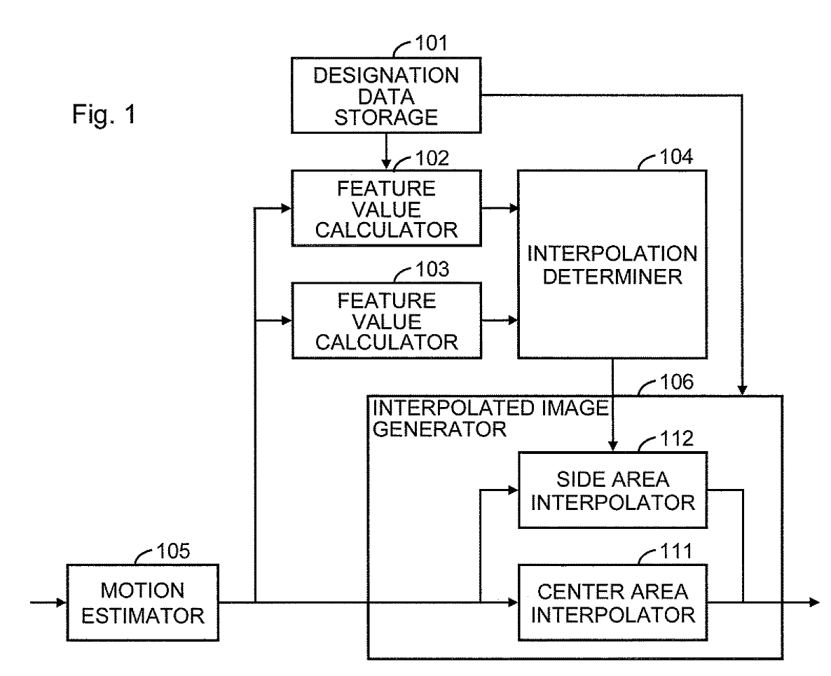

FIG. 1 is a diagram illustrating an exemplary configuration of an image interpolation apparatus according to an embodiment of the present invention. The image interpolation apparatus includes a designation data storage 101, feature value calculators 102 and 103, an interpolation determiner 104, a motion estimator 105 and an interpolated image generator 106.

The designation data storage 101 stores area data for designating an image area at the screen center and outputs the area data to the feature value calculator 102 and the interpolated image generator 106. The motion estimator 105 performs block matching using blocks (rectangular areas) in a predefined size between two input video frames to obtain a motion vector in accordance with the matching result. The obtained motion vector is output to the feature value calculators 102 and 103 and the interpolated image generator 106. The feature value calculator 103 calculates a feature value of a screen for the entire screen, and the feature value calculator 102 calculates a feature value of a screen only within a designated area in accordance with given area data.

The interpolation determiner 104 determines whether the two feature values calculated by the feature value calculators 102 and 103 are matched to determine whether an interpolation at a side area of the screen outside the image area is valid. If the two feature values are matched, the interpolation is determined to be valid. Then, a control signal indicative of interpolation-ON is output to the interpolated image generator 106. If the two feature values are not matched on the other hand, the interpolation is determined to be invalid. Then, a control signal indicative of interpolation-OFF is output to the interpolated image generator 106.

The interpolated image generator 106 includes a center area interpolator 111 and a side area interpolator 112. The center area interpolator 111 generates an interpolated image within the image area on the basis of a motion vector obtained by the motion estimator 105. The side area interpolator 112 generates an interpolated image at a side area of the screen on the basis of a motion vector in accordance with the control signal output from the interpolation determiner 104. The side area interpolator 112 performs the interpolation process on the side area of the screen on the basis of the motion vector in response to an input of the control signal indicative of interpolation-ON, and stops the interpolation process on the side area of the screen in response to an input of the control signal indicative of interpolation-OFF.

Thus, an interpolated frame with interpolation on the entire screen is output in a case of interpolation-ON, and an interpolated frame with interpolation on the designated image area only is output in a case of interpolation-OFF.

Such an image interpolation process allows generation of an interpolated video in adapting to the change through time, if any, of the non-picture area at a side area of the screen. Thus, deterioration of quality due to improper interpolation on a non-picture area may be prevented, obtaining a stably interpolated video.

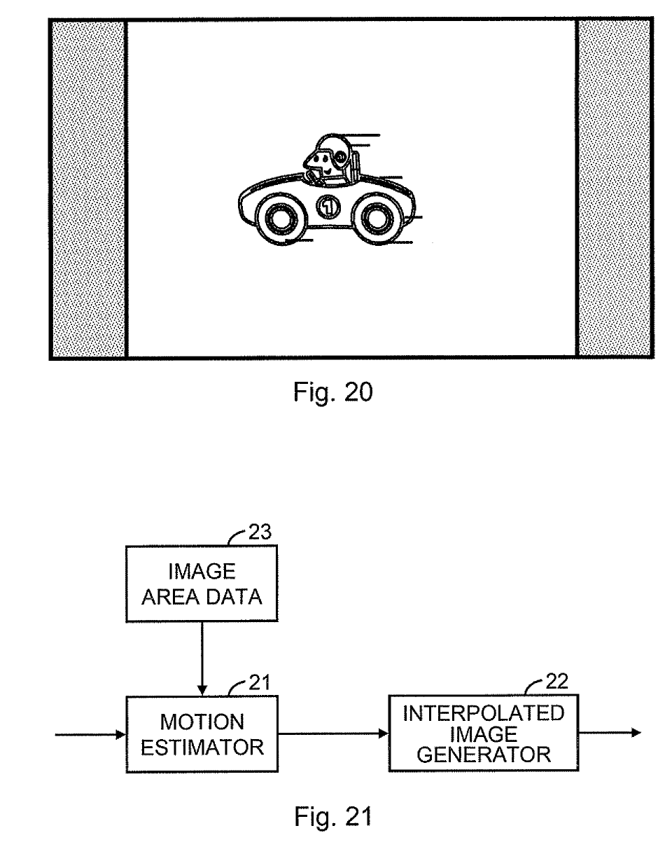

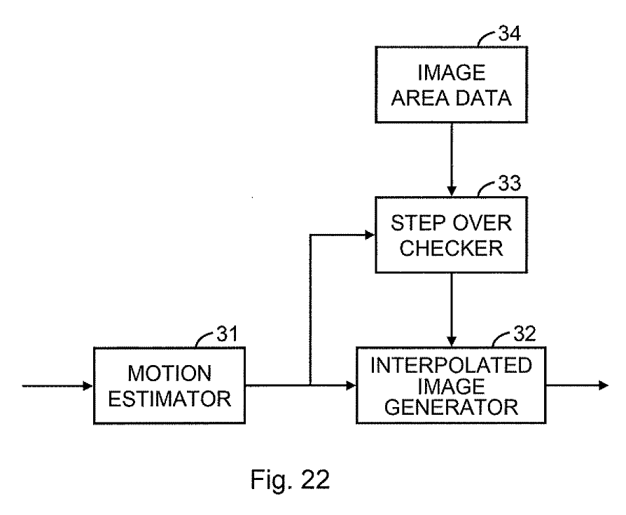

Next, operations by the image interpolation apparatus will be discussed in a case where images having side panels as shown in FIG. 20 are input. In this case, area data designating, as an image area, a center area of the screen, i.e. an entire screen excluding the side panels, is stored as known design data in the designation data storage 101.

The motion estimator 105 can obtain the motion vector on only an area (a searchable area) within the screen of an input video frame, in which the motion estimation is available. As for an area (an unsearchable area) on the fringe of the screen, in which the motion estimation is unavailable, the motion vector is obtained from spatial compensation employing the motion vector of an adjacent area.

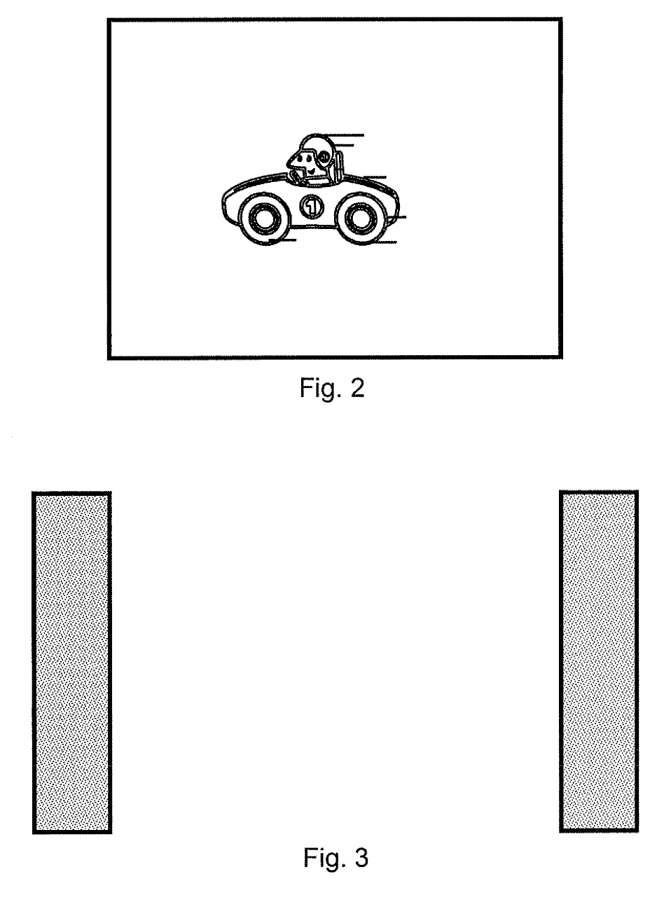

The feature value calculator 103 calculates a feature value, in a searchable area within the screen area shown in FIG. 20, regarding a feature of continuity within the screen. An average speed of horizontal scrolling is suitable as the feature value in a case of side panels. FIG. 2 is a diagram illustrating an image area in a screen with side panels. As shown in FIG. 2, the feature value calculator 102 calculates an average speed of horizontal scrolling on the basis of the motion vector limited to the area excluding side panels.

The interpolation determiner 104 compares the two average speeds of horizontal scrolling. In this case, since the average speed of horizontal scrolling obtained by the feature value calculator 103 includes the speed in the black bar areas (that is, still areas) of the side panels, the two average speeds of horizontal scrolling are unmatched even in a horizontal scrolling video. From the comparison result, the image is determined to include side panels, and the control signal indicative of interpolation-OFF is output to the interpolated image generator 106.

FIG. 3 is a diagram illustrating black bars in side panel areas. The center area interpolator 111 generates an interpolated image within the area in FIG. 2 while the side area interpolator 112 does not perform interpolation process but outputs images of the side panels, shown in FIG. 3, of the input video frame.

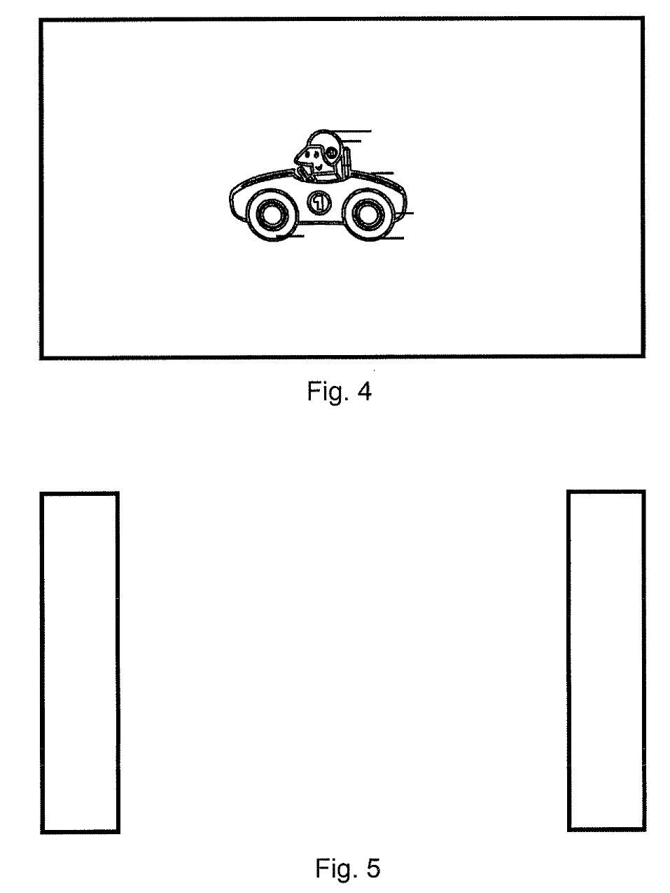

FIG. 4 is a diagram illustrating an entire screen area including side panel areas. Next, operations by the image interpolation apparatus will be discussed in a case where an image on the entire screen as shown in FIG. 4 is input. The feature value calculator 103 calculates an average speed of horizontal scrolling in a searchable area within the entire screen area shown in FIG. 4. The feature value calculator 102 calculates an average speed of horizontal scrolling in a searchable area within the image area in FIG. 2. In this case, since there is no still area like the side panels, the horizontal scrolling speed within the screen is uniform. Therefore, the two average speeds of horizontal scrolling are matched. As a result, the image is determined to be displayed in full screen, and the control signal indicative of interpolation-ON is output to the interpolated image generator 106.

FIG. 5 is a diagram illustrating side panel areas in a screen. The center area interpolator 111 generates an interpolated image within the area in FIG. 2, and the side area interpolator 112 generates an interpolated image within the side panel areas shown in FIG. 5.

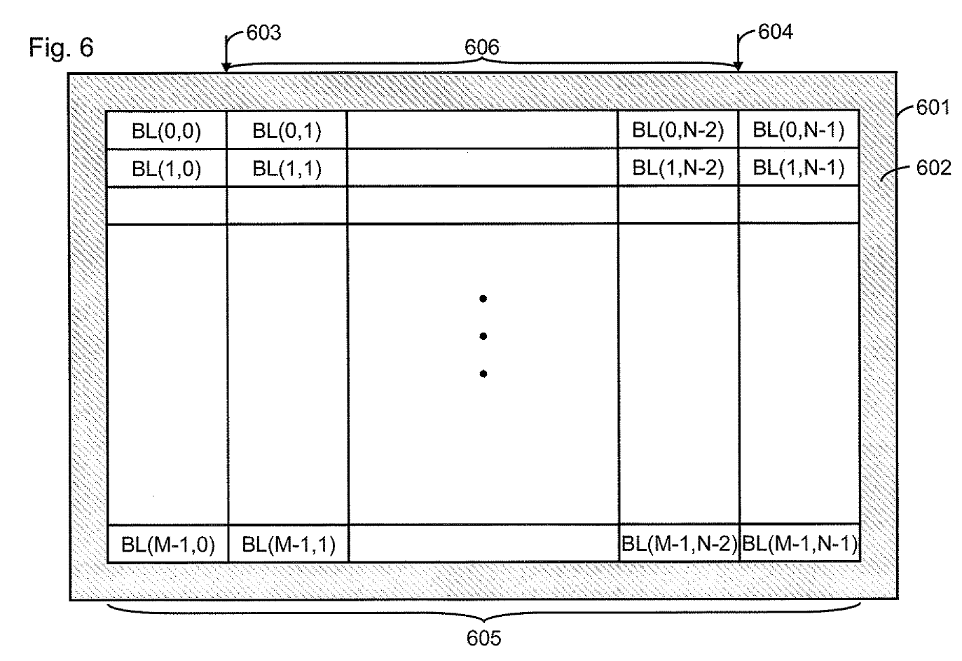

FIG. 6 is a diagram illustrating examples of searchable area and feature value calculation areas within a video frame. The area excluding a shaded unsearchable area 602 from the video frame 601 is the searchable area. The area data output from the designation data storage 101 may be data of borders 603 and 604 of areas which may possibly be a non-picture area. In the above discussed example of side panels, an area between the borders 603 and 604 may be designated as the image area.

One famous method for motion estimation is a block matching method which obtains a motion vector by performing calculation of similarity between data of blocks in a predefined size. Each of grid squares in the searchable area indicates a unit block in the block matching method. The searchable area is divided into N×M blocks. BL(i,j) shown in FIG. 6 denotes a block at the i-th row and j-th column.

The feature value calculator 103 calculates a feature value within a feature value calculation area 605 including all blocks BL(i,j) (where i=0 to M-1, and j=0 to N-1). On the other hand, the feature value calculator 102 calculate a feature value within a feature value calculation area 606 including blocks BL(i,j) (where i=0 to M-1, and j=1 to N-2) between the borders 603 and 604.

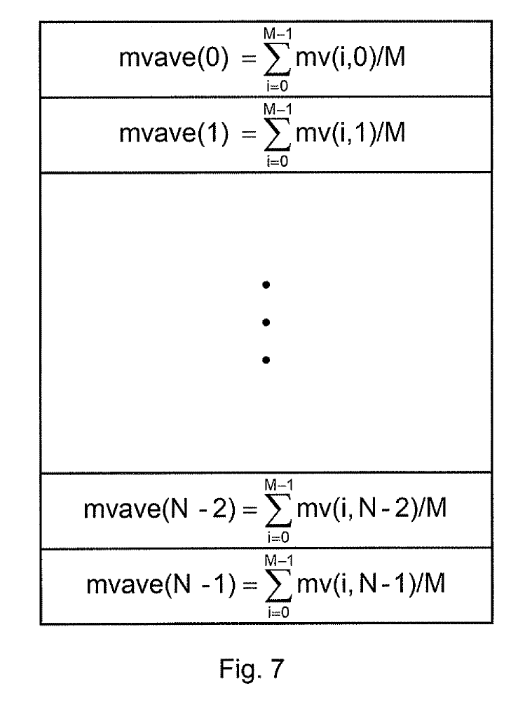

FIG. 7 is a diagram illustrating an example of a method for calculating a feature value. In an example on the side panels, the average speed of horizontal scrolling is suitable as the feature value. The average speed of horizontal scrolling may be obtained by calculating an average motion vector within a screen.

Assume that mv(i,j) denotes a motion vector at the block BL(i,j). The average motion vector within a screen can be obtained by calculating an average value mvave(j) of M mv(i,j) in the vertical direction for each column and calculating an average value of the obtained multiple mvave(j). The feature value calculator 103 calculates an average motion vector mvaveall below, and the feature value calculator 102 calculates an average motion vector mvavesub below.

$$\begin{matrix}mvave ( j ) = \frac{{\sum }_{i = 0}^{M - 1} mv ( i , j )}{M} ( j = 0 , … , N - 1 ) & ( 1 ) \\ mvaveall = \frac{{\sum }_{j = 0}^{N - 1} mvave ( j )}{N} & ( 2 ) \\ mvavesub = \frac{{\sum }_{j = 1}^{N - 2} mvave ( j )}{N - 2} & ( 3 )\end{matrix}$$

The interpolation determiner 104 compares mvaveall and mvavesub. In a case of an image having side panels, mvaveall does not match mvavesub. Therefore, the outside areas of the borders 603 and 604 are determined to be non-picture areas, and the control signal indicative of interpolation-OFF is output.

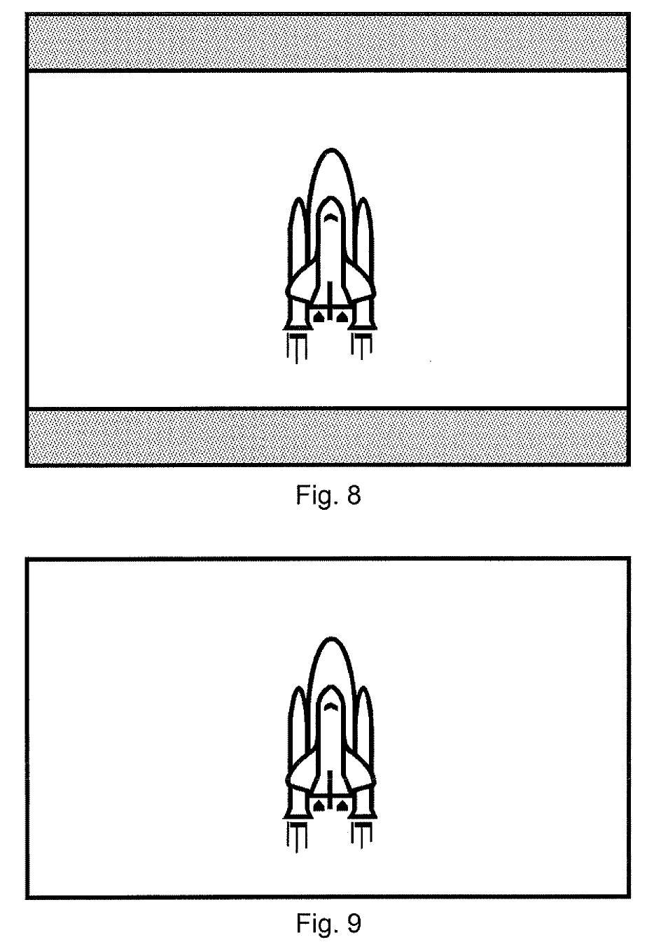

FIG. 8 is a diagram illustrating an entire screen area including black bars of typical letterbox bars. Operations by the image interpolation apparatus will be discussed in a case where images having letterbox bars as shown in FIG. 8 are input. In this example, a screen of a screen size ratio 16:9 is placed within a screen of a screen size ratio 4:3, and area data designating, as an image area, a center area of the screen, i.e. an entire screen excluding the top and bottom black bar areas, is stored as known design data in the designation data storage 101.

The feature value calculator 103 calculates a feature value, in a searchable area within the screen area shown in FIG. 8, regarding a feature of continuity within the screen. An average speed of vertical scrolling is suitable as the feature value in a case of letterbox bars. FIG. 9 is a diagram illustrating an image area in a screen with letterbox bars. As shown in FIG. 9, the feature value calculator 102 calculates an average speed of vertical scrolling on the basis of the motion vector limited to the area excluding letterbox bars.

The interpolation determiner 104 compares the two average speeds of vertical scrolling. In this case, since the average speed of vertical scrolling obtained by the feature value calculator 103 includes the speed in the black bar areas (that is, still areas) of the letterbox bars, the two average speeds of vertical scrolling are unmatched even in a vertical scrolling video. From the comparison result, the image is determined to include letterbox bars, and the control signal indicative of interpolation-OFF is output to the interpolated image generator 106.

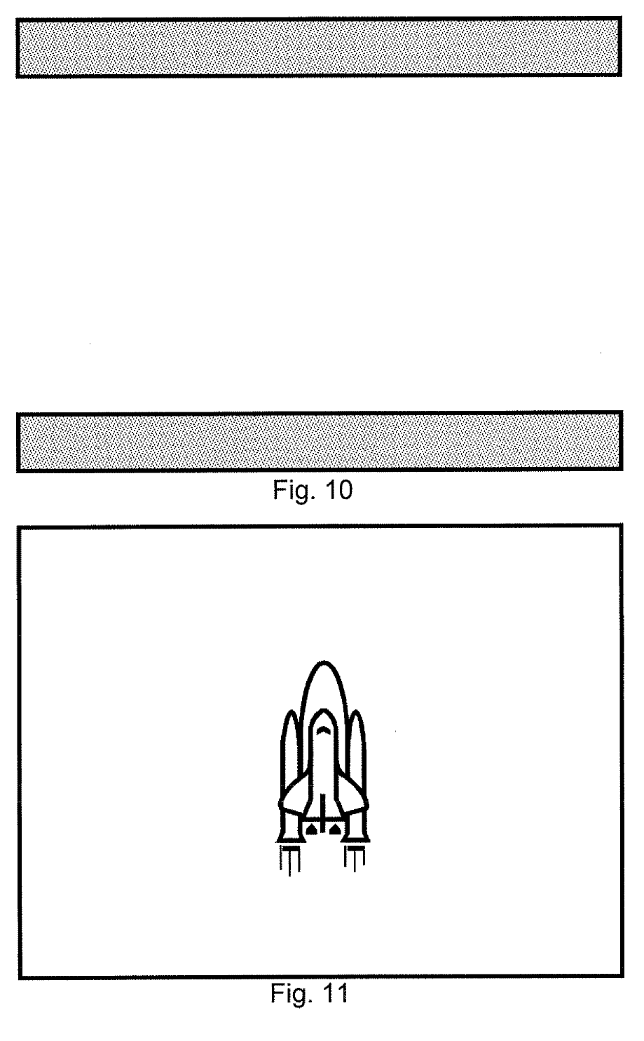

FIG. 10 is a diagram illustrating black bars in letterbox bar areas. The center area interpolator 111 generates an interpolated image within the area in FIG. 9 while the side area interpolator 112 does not perform interpolation process but outputs images of the letterbox bars, shown in FIG. 10, of the input video frame.

FIG. 11 is a diagram illustrating an entire screen area including letterbox bar areas. Operations by the image interpolation apparatus will be discussed in a case where an image on the entire screen as shown in FIG. 11 is input. The feature value calculator 103 calculates an average speed of vertical scrolling in a searchable area within the entire screen area shown in FIG. 11. The feature value calculator 102 calculates an average speed of vertical scrolling in a searchable area within the image area in FIG. 9. In this case, since there is no still area like the letterbox bars, the vertical scrolling speed within the screen is uniform. Therefore, the two average speeds of vertical scrolling are matched. As a result, the image is determined to be displayed in full screen, and the control signal indicative of interpolation-ON is output to the interpolated image generator 106.

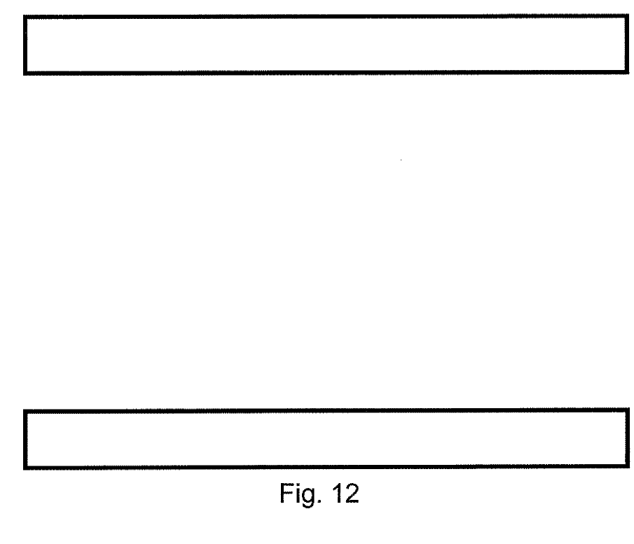

FIG. 12 is a diagram illustrating letterbox bar areas in a screen. The center area interpolator 111 generates an interpolated image within the area in FIG. 9, and the side area interpolator 112 generates an interpolated image within the letterbox bar areas shown in FIG. 12.

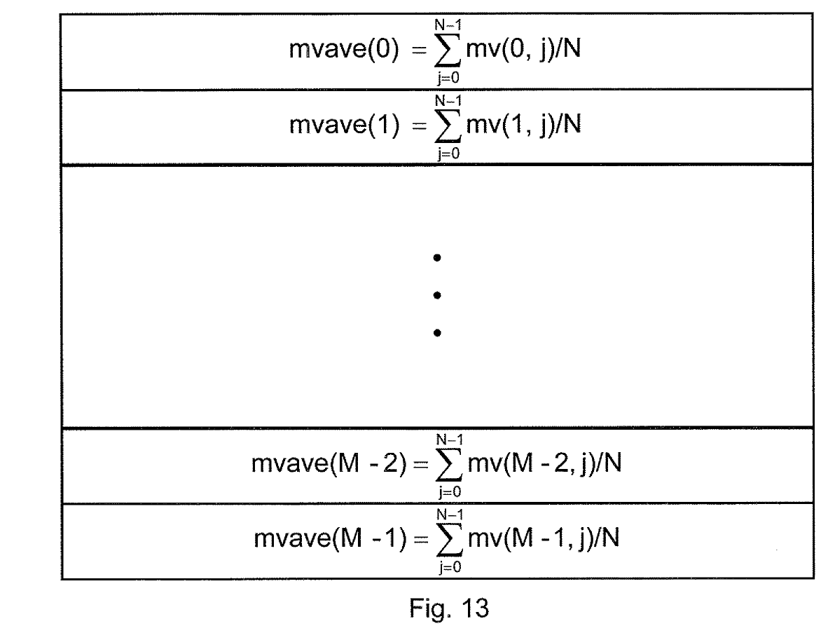

FIG. 13 is a diagram illustrating an example of a method for calculating a feature value in a case of letterbox bars. In this case, the average speed of vertical scrolling is suitable as the feature value. Like the average speed of horizontal scrolling, the average speed of vertical scrolling may be obtained by calculating the average motion vector within a screen. Here, the upper end row indicated by i=0 and the lower end row indicated by i=M-1 correspond to the letterbox bar areas, and M-2 rows indicated by i=1 to M-2 correspond to the image area.

Assume that mv(i,j) denotes a motion vector at the block BL(i,j). The average motion vector within a screen can be obtained by calculating an average value mvave(i) of N mv(i,j) in the horizontal direction for each row and calculating the average value of the obtained multiple mvave(i). The feature value calculator 103 calculates an average motion vector mvaveall below, and the feature value calculator 102 calculates an average motion vector mvavesub below.

$$\begin{matrix}mvave ( i ) = \frac{{\sum }_{j = 0}^{N - 1} mv ( i , j )}{N} ( i = 0 , … , M - 1 ) & ( 4 ) \\ mvaveall = \frac{{\sum }_{i = 0}^{M - 1} mvave ( i )}{M} & ( 5 ) \\ mvavesub = \frac{{\sum }_{i = 1}^{M - 2} mvave ( i )}{M - 2} & ( 6 )\end{matrix}$$

The interpolation determiner 104 compares mvaveall and mvavesub. In a case of an image having letterbox bars, mvaveall does not match mvavesub. Therefore, the upper end area and lower end area are determined to be non-picture areas, and the control signal indicative of interpolation-OFF is output.

Although interpolation-ON/OFF is controlled by using the two feature value calculators on one kind of image area in the embodiment discussed above, three or more feature value calculators may be used for control in a case where multiple kinds of image area are designated in advance.

In this case, one feature value calculator may calculate a feature value of the entire screen, and the other feature value calculators may calculate feature values of respective image areas in accordance with area data. Then, by comparing obtained feature value of the entire screen and obtained feature values of the image areas, the kind of image area and the validity of the interpolation on side areas of the screen are determined.

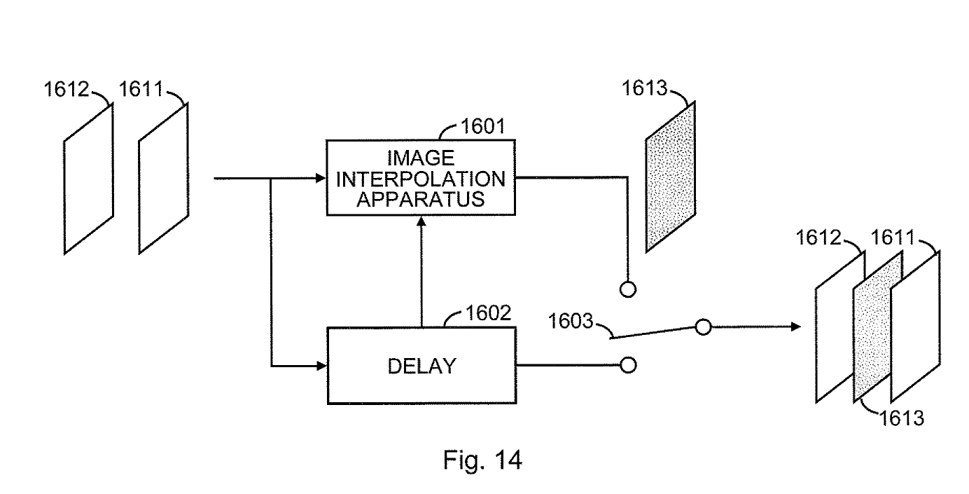

FIG. 14 is a diagram illustrating an exemplary configuration of a frame rate converter employing an image interpolation apparatus according to an embodiment of the present invention. The frame rate converter includes an image interpolation apparatus 1601, a delay 1602, and a switch 1603. The frame rate converter may improve a frame rate of an input video.

The delay 1602 delays successively input video frames 1611 and 1612 by a predefined period of time and outputs them. The image interpolation apparatus 1601 generates an interpolated frame 1613 from a video frame 1612 at a current time and a video frame 1611 at a preceding time output from the delay 1602. The switch 1603 alternately selects and outputs a video frame output from the delay 1602 and an interpolated frame output from the image interpolation apparatus 1601. In this manner, the video frame 1611, interpolated frame 1613 and video frame 1612 are output in order from the frame rate converter.

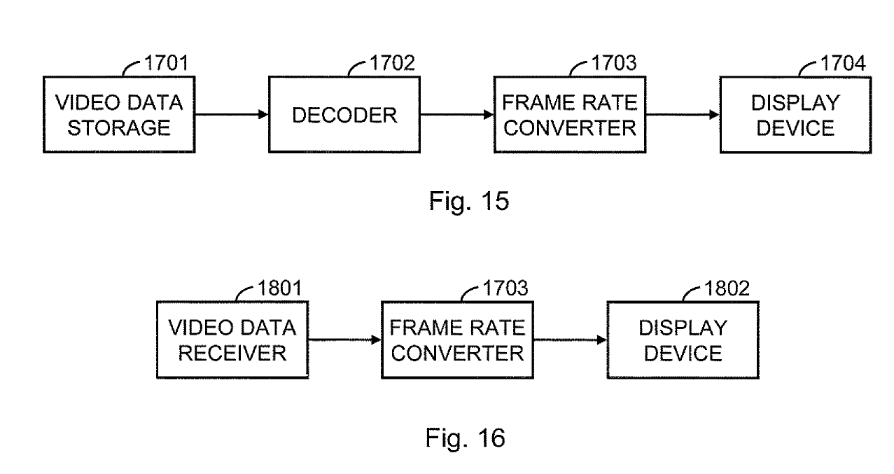

FIG. 15 is a diagram illustrating an exemplary configuration of a video player employing a frame rate converter shown in FIG. 14. The video player includes a video data storage 1701, a decoder 1702, a frame rate converter 1703 and a display device 1704. The decoder 1702 decodes video data stored in the video data storage 1701 and outputs video frames. The frame rate converter 1703 inserts an interpolated frame between video frames. The display device 1704 displays the frames on a screen in time series. The display device 1704 may be configured as an external display device.

FIG. 16 is a diagram illustrating an exemplary configuration of a video display apparatus employing a frame rate converter shown in FIG. 14. The video display apparatus includes a video data receiver 1801, the frame rate converter 1703 and a display device 1802. The video data receiver 1801 receives a video frame via a communication network. The frame rate converter 1703 inserts an interpolated frame between video frames. The display device 1802 displays the frames on a screen in time series. Also in this case, the display device 1802 may be configured as an external display device.

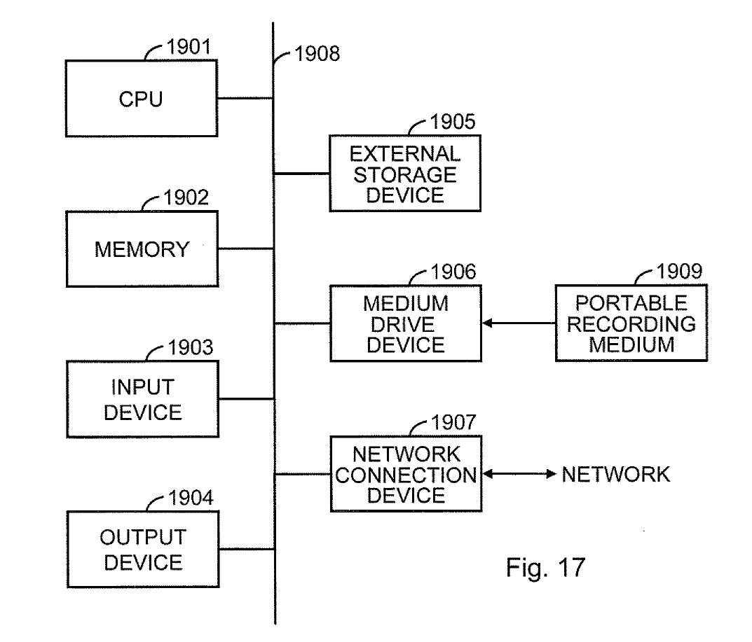

FIG. 17 is a diagram illustrating an exemplary configuration of an information processing apparatus. In a case where the processing by the image interpolation apparatus 1601 and the frame rate converter 1703 is implemented with software, an information processing apparatus (or a computer) as shown in FIG. 17 is used. The information processing apparatus in FIG. 17 includes a CPU (or central processing unit) 1901, a memory 1902, an input device 1903, an output device 1904, an external storage device 1905, a medium drive device 1906 and a network connection device 1907, which are mutually connected via a bus 1908.

The memory 1902 includes a ROM (read only memory) and a RAM (random access memory) and stores a program and data to be used for processing. The CPU 1901 uses the memory 1902 to execute a program for performing an image interpolation process and a frame rate conversion process.

In this case, an input video frame is stored in the memory 1902 as data to be processed, and a searched motion vector thereof is stored in the memory 1902 as data of the processing result. The designation data storage 101 corresponds to the memory 1902, and the feature value calculators 102 and 103, interpolation determiner 104, motion estimator 105, and interpolated image generator 106 correspond to the CPU 1901 executing respective processing in accordance with programs stored in the memory 1902.

The input device 1903 includes a keyboard or a pointing device, for example, and is used for inputting an instruction or data by an operator The output device 1904 includes a display device, a printer, or a loudspeaker, for example, and is used for outputting an inquiry or a processing result to an operator.

The external storage device 1905 includes a magnetic disk device, an optical disk device, a magneto-optical disk device or a tape device, for example. The information processing apparatus may store a program and data in the external storage device 1905 in advance and load them to the memory 1902 for use as required.

The medium drive device 1906 drives a portable recording medium 1909 and accesses recorded contents. The portable recording medium 1909 is an arbitrary computer-readable recording medium including a memory card, a flexible disk, an optical disk and a magneto-optical disk. An operator may store a program and data in the portable recording medium 1909 in advance and load them to the memory 1902 for use as required.

The network connection device 1907 connects to a communication network such as a LAN (local area network) and performs data conversion involved in communication. The information processing apparatus receives a program and data from an external device via the network connection device 1907 and loads them to the memory 1902 for use as required.

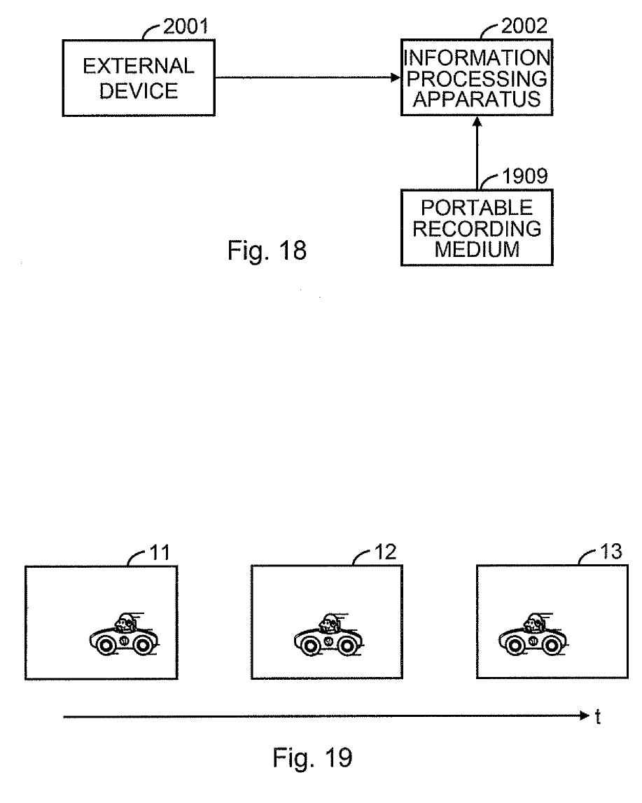

FIG. 18 is a diagram illustrating a method for providing a program and data to an information processing apparatus shown in FIG. 17. A program and data stored in the portable recording medium 1909 or in a database stored in an external device 2001 are loaded to the memory 1902 of an information processing apparatus 2002. The external device 2001 generates a carrier signal that carries the program and data and transmits it to the information processing apparatus 2002 through an arbitrary transmission medium on a communication network. The CPU 1901 performs the process discussed above in accordance with the program by using the data.

As discussed above, even in a case where a non-picture area in a video changes through time, a validity of interpolation can be determined in adapting to the change. Therefore, deterioration of quality due to improper interpolation on a non-picture area may be prevented, obtaining a stably interpolated video.

Also, even in a case where the frame interpolation process is performed at a position adjacent to a display device, external timing for changing the image area data is not required.

What is claimed is:

1. An image interpolation apparatus for generating an interpolated video frame on the basis of a preceding video frame and a following video frame, comprising:
a designation data storage for storing area data designating an image area within a screen area;
a first calculator for calculating a first feature value for the screen area;
a second calculator for calculating a second feature value for the image area in accordance with the area data stored in the designation data storage;
a determiner for determining whether the first feature value matches the second feature value;
a frame generator for generating the interpolated video frame including interpolated data generated on the basis of frame data of the preceding video frame and frame data of the following video frame; and
a controller for controlling the frame generator to generate the interpolated video frame including interpolated data for the image area and non-interpolated data for an area other than the image area within the screen area when a determination result by the determiner indicates a mismatch, said non-interpolated data being the frame data of the preceding video frame or the frame data of the following video frame.

2. The image interpolation apparatus of claim 1, wherein
said first feature value is a value of an average motion vector.

3. The image interpolation apparatus of claim 1, said frame generator including:
a first generator for generating the interpolated data for the image area, and
a second generator for generating interpolated data for the area other than the image area within the screen area.

4. The image interpolation apparatus of claim 3, wherein
said controller controls the second generator to
perform generation of the interpolated data when the determination result by the determiner indicates a match, and
stop generation of the interpolated data when the determination result by the determiner indicates a mismatch.

5. A computer readable medium storing a program of instructions to a computer, said instructions being for executing a method for generating an interpolated video frame on the basis of a preceding video frame and a following video frame, said method comprising:
calculating a first feature value for a screen area;
calculating a second feature value for an image area within the screen area;
determining whether the first feature value matches the second feature value;
generating the interpolated video frame including interpolated data generated on the basis of frame data of the preceding video frame and frame data of the following video frame; and
controlling generation of the interpolated video frame in accordance with a determination result in the operation of determining whether the first feature value matches the second feature value.

6. The computer readable medium of claim 5, wherein, in the operation of controlling generation of the interpolated video frame,
the generation of the interpolated video frame is controlled as to generate the interpolated video frame including interpolated data for the image area and non-interpolated data for an area other than the image area within the screen area when the determination result indicates a mismatch, said non-interpolated data being the frame data of the preceding video frame or the frame data of the following video frame.

7. An image interpolation method executed by an image interpolation apparatus for generating an interpolated video frame on the basis of a preceding video frame and a following video frame, said method comprising:
calculating a first feature value for a screen area;
calculating a second feature value for an image area within the screen area;
determining whether the first feature value matches the second feature value;
generating the interpolated video frame including interpolated data generated on the basis of frame data of the preceding video frame and frame data of the following video frame; and
controlling generation of the interpolated video frame in accordance with a determination result in the operation of determining whether the first feature value matches the second feature value.

8. The image interpolation method of claim 7, wherein, in the operation of controlling generation of the interpolated video frame,
the generation of the interpolated video frame is controlled as to generate the interpolated video frame including interpolated data for the image area and non-interpolated data for an area other than the image area within the screen area when the determination result indicates a mismatch, said non-interpolated data being the frame data of the preceding video frame or the frame data of the following video frame.
